(19) United States
(12) Patent Application Publication
(10) Pub. No.: US 2023/0308267 A1
(43) Pub. Date: Sep. 28, 2023

(54) SIGNAL PROCESSING SYSTEM

(71) Applicant: TAMAGAWA UNIVERSITY AND TAMAGAWA ACADEMY, Tokyo (JP)

(72) Inventors: Fumio FUTAMI, Tokyo (JP); Kentaro KATO, Tokyo (JP); Ken TANIZAWA, Tokyo (JP)

(73) Assignee: TAMAGAWA UNIVERSITY AND TAMAGAWA ACADEMY, Tokyo (JP)

(21) Appl. No.: 18/248,343

(22) PCT Filed: Oct. 8, 2020
(86) PCT No.: PCT/JP2020/038188

§ 371 Date: May 30, 2023

(51) Int. Cl. H04L 9/08

(52) U.S. Cl. CPC H04L 9/0852; H04L 2209/08

(57) ABSTRACT

This invention addresses the problem of improving safety in data transmission/reception, and improving the convenience thereof. A base selection unit 123 of an optical transmission device 1 selects a base for arranging each piece of unit information on an IQ plane. A randomization amount adjustment unit 125 adjusts, on the basis of feedback, the randomization amount in random arrangement of the unit information pieces on the IQ plane. A cryptography signal generation unit 13 generates, as an optical signal, multi-value information equivalent to the random arrangement of the unit information pieces on the IQ plane, within the range of the adjusted randomization amount, in accordance with the selected base. An identification circuit unit 222 of an optical reception device 2 identifies, on the basis of the received optical signal, each of the unit information pieces constituting the multi-value information. A communication quality monitoring unit 24 evaluates the results of identifying the unit information pieces. A feedback unit 25 feeds back the evaluation results to the transmission device. The problem is solved thereby.

### TECHNICAL FIELD

The present invention relates to a signal processing system.

### BACKGROUND ART

In recent years, security measures have become increasingly important in information and communications. Network systems that make up the Internet are described in the OSI reference model established by the International Organization for Standardization. The OSI reference model is split into seven layers, from the layer 1 physical layer to the layer 7 application layer, and the interfaces that connect respective layers are standardized or de facto standardized. The lowest layer from among the seven layers is the physical layer which is responsible for actual transmission and reception of signals by wire or wirelessly. Presently, security (which relies on mathematical ciphers in many cases) is implemented at layer 2 and above, and security measures are not performed in the physical layer. However, there is the risk of eavesdropping in the physical layer. For example, in optical fiber communication which is representative of wired communication, it is possible in principle to introduce a branch into an optical fiber, and extract some of the signal power to thereby steal large amounts of information in one occasion. Accordingly, the applicant is developing a predetermined protocol given in Patent Document 1, for example, as an encryption technique for the physical layer.
Patent Document 1: Japanese Patent No. 5170586

### DISCLOSURE OF THE INVENTION

### Problems to be Solved by the Invention

Although details will be described below, in a predetermined protocol described in Patent Document 1 described above, pieces of unit information taking multi-levels (for example, bit strings of a predetermined length) can be transmitted using a nature of shot noise in an optical signal such that signals indicating the pieces of unit information cannot be mutually identified. Here, as the noise is greater in the optical signal, it become more difficult for a third party who eavesdrops on the optical signal to identify (decrypt) the unit information. Therefore, there is a demand to add larger fluctuation (noise) to a transmission device within a range where the unit information can be identified by a legitimate receiver. However, when the noise in the optical signal is made too large, even a legitimate receiver cannot identify the unit information. Furthermore, the noise in the optical signal fluctuates depending on characteristics of a transmission path for the optical signal and surrounding environments.

The present invention has been made in light of such a situation, and an object of the present invention is to improve security and convenience in transmission and reception of data.

### Means for Solving the Problems

To achieve the above object, a signal processing system according to an aspect of the present invention includes at least:
a transmission device that transmits, as an optical signal, multi-level information in which one or more pieces of multi-level unit information are arranged; and
a reception device that receives the optical signal transmitted from the transmission device, the transmission device including:
a basis selection unit for selecting a basis used to arrange the one or more pieces of multi-level unit information on an IQ plane;
a randomization amount adjustment unit for adjusting the randomization amount in the case of random arrangement of the one or more pieces or multi-level unit information on the IQ plane;
an optical signal generation unit for generating, as an optical signal, the multi-level information equivalent to the random arrangement of the one or more pieces of multi-level unit information on the IQ plane within a range of the randomization amount according to the basis; and
an optical signal transmission unit for transmitting the optical signal to the reception device,
the reception device including:
an optical signal reception unit for receiving the optical signal transmitted from the transmission device;
an identification unit for identifying the one or more pieces of unit information making up the multi-level information, based on the optical signal received by the optical signal reception unit;
an evaluation unit for evaluating a result of the one or more pieces of unit information identified by the identification unit; and
a feedback unit for feeding back a result evaluated by the evaluation unit to the transmission device.

### Effects of the Invention

According to the present invention, it is possible to improve security and convenience in transmission and reception of data.

### BRIEF DESCRIPTION OF THE DRAWINGS

FIG. 1 is a block diagram showing an example of a configuration of a signal processing system according to an embodiment of the present invention;

FIG. 2 is a view for describing an overview of principles of a Y-00 optical communication quantum cryptography applied to the signal processing system of FIG. 1;

FIG. 3 is an enlarged view of C modulation shown in FIG. 2 such that in order to enable visual recognition of the arrangement of three adjacent symbol points among the arrangement of N=4096 symbol points in the phase modulation of C modulation shown in FIG. 2;

FIG. 4 is a diagram showing an example of a signal to be transmitted when each of the symbol points in the A modulation shown in FIG. 2 is randomized;

FIG. 5 is a schematic diagram showing a range of allowable randomization amounts of θrand at stage B shown in FIG. 4;

FIG. 6 is a diagram showing an example in a case where a basis related to symbol points different from the A modulation shown in FIG. 2 is selected from the example shown in FIG. 4;

FIG. 7 is a schematic diagram showing a range of allowable randomization amounts of θrand at stage B shown in FIG. 6;

FIG. 8 is a block diagram showing a detailed configuration example of the signal processing system shown in FIG. 1;

FIG. 9 is a block diagram showing another example different from that shown in FIG. 8 in the detailed configuration example of the optical transmission device shown in FIG. 1;

FIG. 10 is a block diagram showing another example different from those shown in FIGS. 8 and 9 in the detailed configuration example of the optical transmission device shown in FIG. 1;

FIG. 11 is a block diagram showing another example different from those shown in FIGS. 8 to 10 in the detailed configuration example of the optical transmission device shown in FIG. 1; and

FIG. 12 is a block diagram showing another example different from those shown in FIGS. 8 to 11 in the detailed configuration example of the optical transmission device shown in FIG. 1.

### PREFERRED MODE FOR CARRYING OUT THE INVENTION

An embodiment of the present invention will be described below with reference to the drawings.

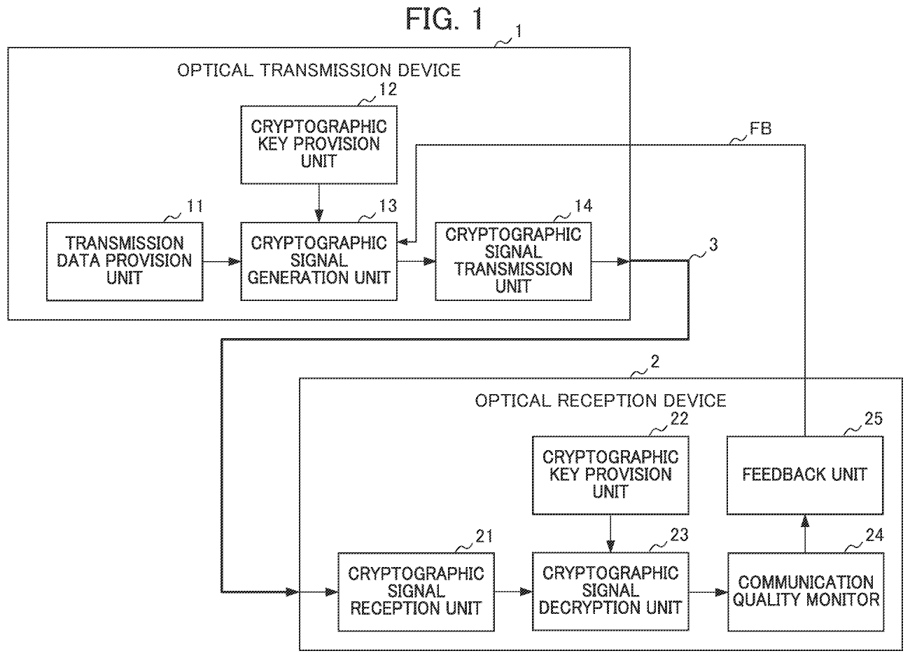

FIG. 1 is a block diagram showing an example of a configuration of a signal processing system according to an embodiment of the present invention. The signal processing system in the example of FIG. 1 includes an optical transmission device 1, an optical reception device 2, and an optical communication cable 3 for connecting these devices.

The optical transmission device 1 includes transmission data provision unit 11, a cryptographic key provision unit 12, a cryptographic signal generation unit 13, and a cryptographic signal transmission unit 14.

The transmission data provision unit 11 generates plaintext data to be transmitted or acquires plaintext data from a generation source (not shown), and provides the plaintext data to the cryptographic signal generation unit 13 as transmission data. The cryptographic key provision unit 12 provides the cryptographic signal generation unit 13 with a cryptographic key to use in encryption at the cryptographic signal generation unit 13. It is sufficient if the cryptographic key is a key that can be used in encryption and decryption by the optical transmission device 1 and the optical reception device 2, and there is no limitation in particular on the source of provision of the cryptographic key (place where the cryptographic key is generated or place where the cryptographic key is stored), a method of providing the cryptographic key, and methods of encryption and decryption. The cryptographic signal generation unit 13 encrypts the transmission data provided from the transmission data provision unit 11 using the cryptographic key provided from the cryptographic key provision unit 12, and provides encrypted transmission data to the cryptographic signal transmission unit 14 which will be described below. The optical signal generated from the cryptographic signal generation unit 13, that is, the optical signal superimposed with the encrypted transmission data is hereinafter referred to as a “cryptographic signal”. Although details will be described below, the cryptographic signal generation unit 13 generates a cryptographic signal based on the evaluation fed back from the optical reception device 2. The cryptographic signal transmission unit 14 transmits the cryptographic signal generated from the cryptographic signal generation unit 13 to the optical reception device 2 via the optical communication cable 3 after amplifying the cryptographic signal as necessary.

As described above, the cryptographic signal (optical signal) is output from the optical transmission device 1, transferred through the optical communication cable 3, and received by the optical reception device 2. The optical reception device decrypts the received cryptographic signal, thereby causing the plaintext data (transmission data) to be restored. For this reason, the optical reception device 2 includes a cryptographic signal reception unit 21, a cryptographic key provision unit 22, a cryptographic signal decryption unit 23, communication quality monitor 24, and a feedback unit 25.

The cryptographic signal reception unit 21 receives the cryptographic signal (optical signal), and provides the signal to the cryptographic signal decryption unit 23 after amplifying and compensating the signal as necessary. The cryptographic key provision unit 22 provides the cryptographic signal decryption unit 23 with a cryptographic key that is used when decrypting cryptographic signal. The cryptographic signal decryption unit 23 decrypts the cryptographic signal provided from the cryptographic signal reception unit 21, uses the cryptographic key provided from the cryptographic key provision unit 22 to, and thus restores the plaintext data (transmission data). The communication quality monitor 24 generates and outputs an evaluation related to monitoring (confirmation and observation) of the communication quality of the plaintext data (transmission data) restored by the cryptographic signal decryption unit 23. The feedback unit 25 feeds back the evaluation related to the monitoring of the communication quality generated and output by the communication quality monitor 24 to the optical transmission device 1.

Thus, in the present embodiment, the cryptographic signal is employed as an example of an optical signal transferred by the optical communication cable 3. For this reason, in the example of FIG. 1, optical fiber communication, which is representative of wired communication, is employed as a method of communicating the cryptographic signal. In optical fiber communication, it is theoretically possible for a third party to steal large amounts of information (here, cryptographic signal) at once by introducing a branch into an optical fiber and extracting some of the signal power. Therefore, even when the cryptographic signal is stolen, there is a need for a method that the meaning and content of the cryptographic signal, that is, the content of the plaintext (transmission data) cannot be recognized by a third party. As such method, the applicant has developed a technique using the Y-00 optical communication quantum cryptography.

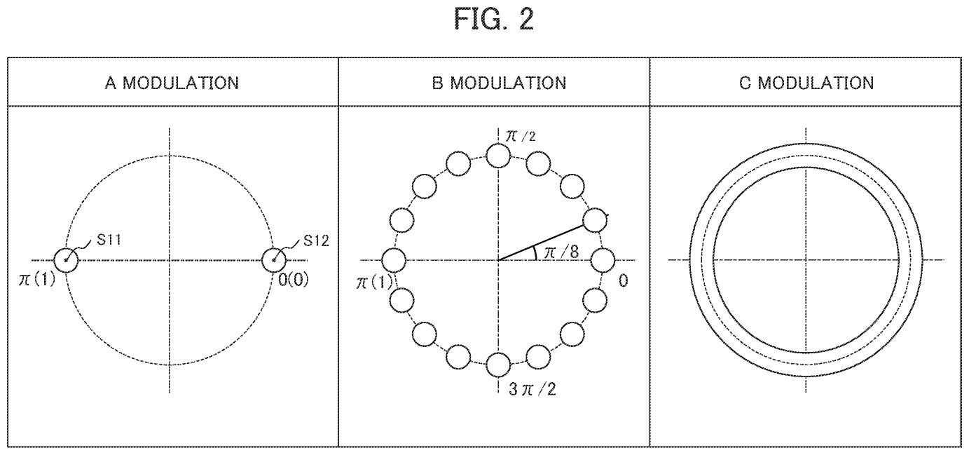

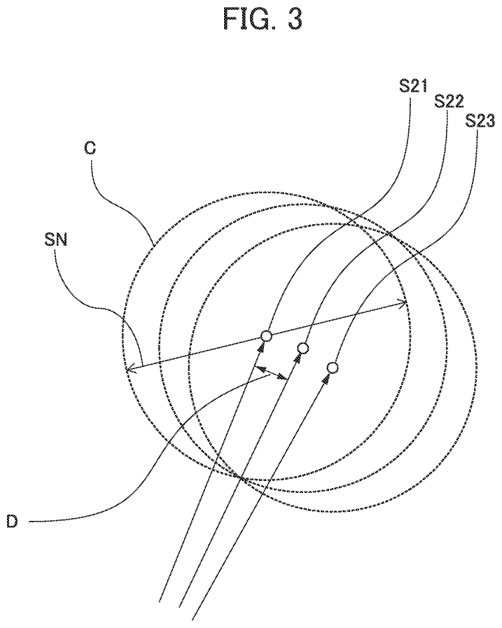

The Y-00 optical communication quantum cryptography is characterized by “a ciphertext cannot be acquired correctly due to the effect of quantum noise”, and has been developed by the applicant. In the Y-00 optical communication quantum cryptography, transmission data (plaintext) is represented by one or more aggregates of bit data of “0” or “1”. Each bit data that makes up the transmission data is modulated by a predetermined algorithm to a predetermined value among M (M being an integer value of 2 or more) values. Therefore, the numerical value M is hereinafter referred to as “modulation number M”. In the Y-00 optical communication quantum cryptography, encryption of transmission data (plaintext) is performed by modulating at least one of the phase or amplitude of an optical signal (carrier wave) by one of the modulation number M of levels, in accordance with a cryptographic key present on the encrypting side and the decrypting side. By making the modulation number M a very high level, the characteristic of “not allowing an eavesdropper to correctly obtain ciphertext due to effects of quantum noise” is realized. Regarding the “predetermined protocol” employed in the Y-00 optical communication quantum cryptography, please refer to Japanese Patent No. 5170586, for example. With reference to FIG. 2 and FIG. 3, a simple description is given regarding an overview of the principles of the Y-00 optical communication quantum cryptography, taking phase modulation as an example.

FIG. 2 is a view for describing an overview of principles of a Y-00 optical communication quantum cryptography applied to the signal processing system of FIG. 1. FIG. 3 is an enlarged view of C modulation shown in FIG. 2 such that in order to enable visual recognition of the arrangement of three adjacent symbol points among the arrangement of M=4096 symbol points in the phase modulation of C modulation shown in FIG. 2. The A modulation through C modulation shown in FIG. 2 show IQ planes that represent the phase and amplitude (intensity) of an optical signal, with the intersection of the vertical axis and the horizontal axis as the origin. When a point on one of these IQ planes is determined, the phase and amplitude of the optical signal are uniquely determined. Taking the origin of the IQ plane as the start point, the phase is the angle formed between the line segment having an endpoint at the point representing the optical signal and the line segment representing phase 0. In contrast, the amplitude is the distance between the point representing the optical signal and the origin of the IQ plane.

The A modulation shown in FIG. 2 is to facilitate understanding of the Y-00 optical communication quantum cryptography, and is a graph for describing the principles of normal two-level modulation. For example, if plaintext (transmission data) is superimposed as is on an optical signal (carrier wave) and transmitted, two-level modulation indicated as the A modulation shown in FIG. 2 will be performed on each item of bit data (1 or 0) that makes up the plaintext. In this case, in the A modulation shown in FIG. 2, the arrangement of a point (hereinafter, referred to as a “symbol point”) indicating the optical signal after phase modulation when the bit data is “0” is the arrangement of a symbol point S11 given by 0 (0) on the right side on the horizontal axis, in other words an arrangement where the phase is 0. In contrast, the arrangement of a symbol point after phase modulation when the bit data is 1 the arrangement of a symbol point S12 given by π(1) on the left side on the horizontal axis, in other words an arrangement when the phase is π. Here, the solid-line circle surrounding the symbol point S11 shows an example of the fluctuation range of the Quantum noise when the optical signal of the symbol point S11 is received. For a symbol point S12, similarly, an example of fluctuation range of the quantum noise is shown as a solid-line circle surrounding the symbol point S12.

The B modulation shown in FIG. 2 is to describe principles of phase modulation when the modulation number M=16, in a case where the Y-00 optical communication quantum cryptography is employed. In the case of the example of B modulation shown in FIG. 2, a random level from among eight levels is generated by using the cryptographic key, for each item of bit data that makes up the plaintext. The phase modulation is performed by, for each bit, rotating the phase of the symbol point in the normal two-level modulation indicated as the A modulation shown in FIG. 2 (the point for phase 0 corresponding to 0 and the point for phase n corresponding to 1) in the IQ plane in accordance with a level from among the eight levels and is generated randomly. Because the value that bit data can take is binary—either “0” or “1”, as a result, when the phase modulation of the example of B modulation shown in FIG. 2 is performed, the arrangement of the symbol points becomes an arrangement of 16 points (number of modulations M=16) for which the phase respectively differs by π/8.

However, in the case of the example of B modulation shown in FIG. 2, the value—“0” or “1”—that the bit data can take is merely modulated to one of the levels from among the modulation number M=16 levels. Therefore, if the optical signal (cryptographic signal), which has the arrangement of 16 symbol points, is intercepted, there is the risk that the meaning of its content—in other words the content of the plaintext (transmission data)—will be recognized (decrypted) by a third party. In other words, the security of the Y-00 optical communication quantum cryptography is not sufficient at only around the modulation number M=16. Accordingly, in practice, as indicated by the C modulation shown in FIG. 2, a very high level, for example 4096, is employed as the modulation number M, and the security of the Y-00 optical communication quantum cryptography is improved.

The C modulation shown in FIG. 2 is to describe principles of phase modulation when the modulation number M=4096, in a case where the Y-00 optical communication quantum cryptography is employed. FIG. 3 is an enlarged view of C modulation shown in FIG. 2 such that in order to enable visual recognition of the arrangement of three adjacent symbol points among the arrangement of M=4096 symbol points in the phase modulation of C modulation shown in FIG. 2. As shown in FIG. 3, for each symbol point from S21 to S23, there is fluctuation due to shot noise (quantum noise) in only a range SN. Specifically, for example, the solid-line circle C surrounding the symbol point S21 shown in FIG. 3 shows an example of the fluctuation range SN of the quantum noise when the optical signal of the symbol point S21 is received. The shot noise is noise due to the quantum nature of light, is truly random, and has a characteristic of being one of the laws of physics that is not set aside. When phase modulation with a very high level, such as 4096, as the modulation number M, is performed, adjacent symbol points cannot be discriminated from one another because they are obscured by shot noise, as shown in FIG. 3. Specifically, when the distance D between two adjacent symbol points S21 and S22 is sufficiently smaller than the range SN of shot noise (when phase modulation with a very high level as the modulation number M is performed so as to make the distance D this small), it is difficult to determine the position of the original symbol points from phase information measured at a receiving side. In other words, for example, it is assumed that the phase measured on the receiving side at a certain time corresponds to the position of the symbol point 322 shown in FIG. 3. In such a case, it not possible to distinguish whether the symbol point is something transmitted as an optical signal for a symbol point S22 or whether this was actually something transmitted as an optical signal for symbol points S21 and S23 but was measured as the symbol point S22 due to the affect of shot noise. To summarize the above, modulation where the modulation number M is very large is employed in the Y-00 optical communication quantum cryptography.

Although the phase modulation is used in the example of FIGS. 2 and 3, amplitude (intensity) modulation may be employed instead of or in addition to phase modulation. In other words, optical signal modulation using the Y-00 protocol can employ any modulation scheme such as intensity modulation, amplitude modulation, phase modulation, frequency modulation, and quadrature amplitude modulation.

In addition, as described above, with the Y-00 optical communication quantum cryptography, it becomes possible to make the distance n between two symbol points sufficiently smaller than the range SiN of shot noise in any modulation scheme, and the characteristic “not allowing an eavesdropper to correctly obtain ciphertext due to effects of quantum noise” becomes possible. In addition, although quantum noise ensures security, in practice an eavesdropper is prevented from obtaining the correct ciphertext due to the effect of all noise, including classical noise such as thermal noise in addition to quantum noise.

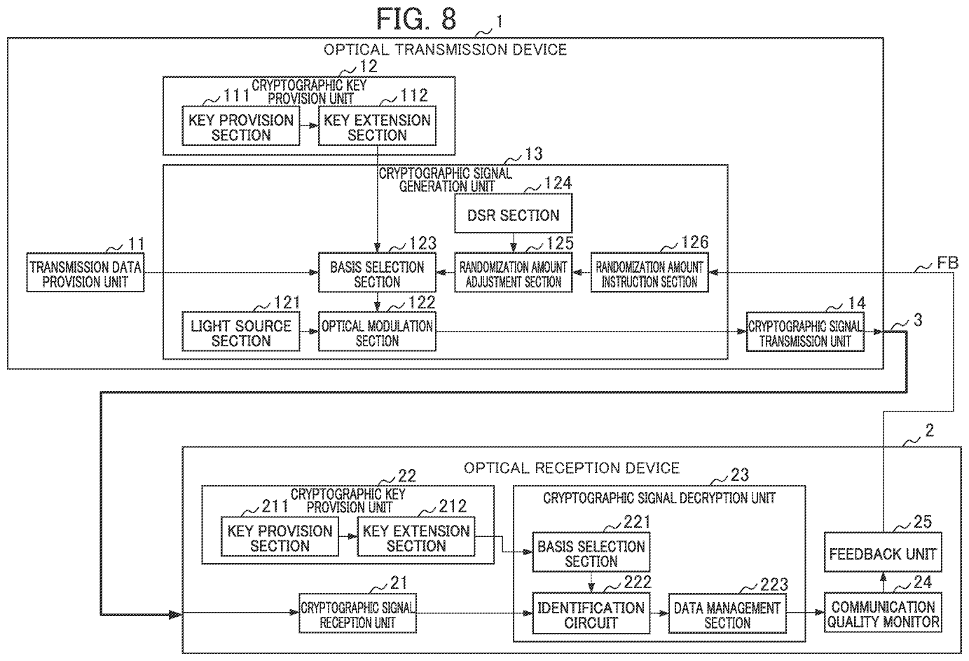

Therefore, in order to further add “noise” of the cryptographic signal, the optical transmission device 1 of the present embodiment employs a technique of deliberate signal randomization (hereinafter, referred to as “DSR”). Although details will be described with reference to FIGS. 8 to 12, the cryptographic signal generation unit 13 of the optical transmission device 1 can execute processing related to DSR. In the cryptographic signal that has undergone the processing related to DSR, the size of the solid-line circle C surrounding the symbol point S21 in FIG. 3 is increased by the amount of randomness augmented by the fluctuation range SN of the quantum noise and the processing related to DSR. In other words, the randomness of the cryptographic signal is augmented, that is, the noise masking quantity becomes larger. As a result, even if a third party eavesdrops the cryptographic signal, the risk is reduced that the cryptographic signal is decrypted by the third party. In addition, the randomness due to the appropriate processing related to DSR can be processed as mere noise that does not contribute to the difficulty of identification of the cryptographic signal for a legitimate receiver of the cryptographic signal. In other words, there is no need for the reverse processing of the processing related to DSR on the side of the legitimate receiver. In other words, the technique of DSR improves the security of data transmission/reception without increasing the cost of the optical reception device 2 used by the legitimate receiver.

The security of the Y-00 optical communication quantum cryptography will be described below using the noise maskinq quantity Γ. As an index of security in a Y-00 optical quantum cryptography, the noise masking quantity Γ corresponding to “how many adjacent symbols are masked by shot noise” can be used. Specifically, a description will be made in this specification with respect to a case where “the number of symbol points falling within the range of the standard deviation when the noise distribution is approximated as a Gaussian distribution” is defined as the noise masking quantity Γ. Although the concept of the noise masking quantity Γ is applicable to other than the shot noise distribution, the noise masking quantity Γ related to the shot noise will be described below.

As described above with reference to FIG. 3, when the distance D between two adjacent symbol points is sufficiently smaller than the range SN of the shot noise, it is difficult to determine the position of the original symbol point from the phase information measured on the receiving side. In optical communication, when an optical signal having an intensity sufficient for high-speed communication is employed, the distribution of the amount of shot noise (fluctuation range) can be approximated as a Gaussian distribution. In other words, for the noise masking quantity Γ in this example, the distance (radius) corresponding to the range SN of the shot noise described above with reference to FIG. 3 employs the standard deviation of the Gaussian distribution of shot noise.

In other words, the noise masking quantity Γ is the number of other symbol points included in the range SN of shot noise. In other words, the noise masking quantity Γ indicates the number of other symbol points of which distance D from a certain symbol point is smaller than the range SN of shot noise. In other words, the noise masking quantity Γ is proportional to cipher strength of the cryptographic signal.

For example, when the phase modulation scheme is employed in the Y-00 optical quantum cryptography, the noise masking quantity Γ is represented by Formula (1) below.

$$Γ = \frac{M}{4 π} \sqrt{\frac{R \cdot {hv}_{0}}{{P}_{0}}} \qquad ( 1 )$$

Here, the modulation number M is the number of candidate phases modulated for encryption. Further, the symbol rate R is a number indicating how many symbol points are sent per unit time. Further, the Planck's constant h is a physical constant and is a constant of proportionality related to the energy and frequency of photons. The frequency ν₀ is a frequency of the signal. The power P₀ is a number representing power of the signal.

When the noise masking quantity Γ is a sufficiently large value, masking by shot noise works. In other words, the Y-00 optical quantum cryptography works effectively as a cryptography. Specifically, for example, when such a value is one or more which is enough large value to exhibit the effect of masking due to the shot noise, higher security is achieved.

As described above, the noise in the optical signal fluctuates depending on characteristics of the transmission path for the optical signal and surrounding environments. Therefore, the noise in the noise masking quantity Γ can include all kinds of noise, including the noise in the optical signal fluctuating depending on characteristics of the transmission path for the optical signal and surrounding environments and the classical noise such as thermal noise.

In other words, the noise masking quantity Γ is not limited to the noise masking quantity Γ related to the shot noise disclosed in Formula (1) described above. In other words, the range of the noise masking quantity Γ is not limited to the range of the standard deviation when the noise distribution is approximated as a Gaussian distribution. Specifically, for example, it is sufficient as long as there is the number of symbol points included in the range of the noise including the characteristics of the transmission path (including various optical signal processing devices) for the optical signal and the surrounding environments in addition to the noise due to the shot noise described above. Therefore, the noise distribution measured actually is acquired, and the variation of the acquired distribution may be used as the range.

To summarize the above, it is sufficient if the distance between two adjacent symbol points is sufficiently smaller than the range of all kinds of noise including the classical noise such as thermal noise. In other words, when receiving the optical signal transmitted from the optical transmission device 1, it is sufficient if the noise masking quantity due to all kinds of “noise” including the classical noise such as thermal noise is one or more. Randomization by the processing related to DSR in the present embodiment functions as one kind of noise included all kinds of “noise” including the classical noise such as thermal noise described above.

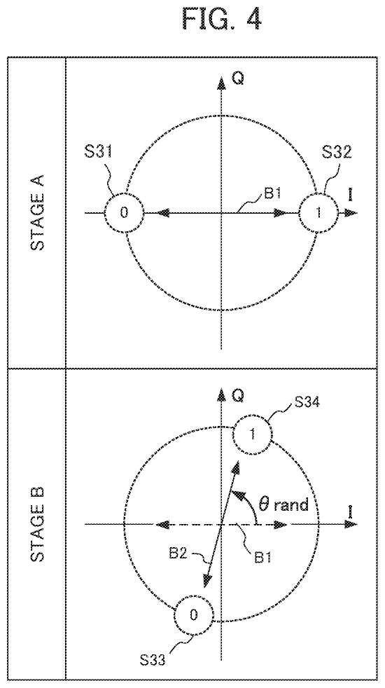

An example of a flow of randomization by the processing related to DSR in the Y-00 optical quantum cryptography will be described below with reference to FIGS. 4 to 7.

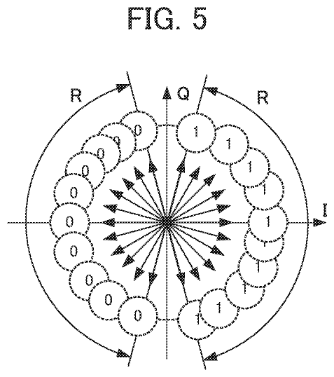

For easy understanding, first, an example of randomization in the A modulation shown in FIG. 2, that is, the normal two-level modulation will be described with reference to FIGS. 4 and 5. FIG. 4 is a diagram showing an example of a flow of randomization when each of the symbol points in the A modulation shown in FIG. 2 is randomized. In other words, 1-bit unit information that takes a binary value of 0 (zero) or 1 is used as unit information that takes a multi-level, and a basis for normal two-level modulation is used as a basis for transmitting the 1-bit unit information as a Y-00 optical quantum cryptography.

First, candidates for basis are selected as the basis for transmitting as the Y-00 optical quantum cryptography. In stage A shown in FIG. 4, symbol points S31 and S32 representing binary unit information of 0 (zero) and 1 are arranged on an IQ plane according to a basis B1 selected as a candidate for basis. The basis B1 in stage A shown in FIG. 4 is selected as a candidate for basis, and is a basis used for transmitting the binary unit information in a normal phase modulation parallel to an axis I making up the IQ plane. In other words, at stage A in FIG. 4, the symbol points S31 and S32 corresponding to 0 (zero) and 1, respectively, are arranged on the axis I.

Next, the candidates for basis are randomized by being rotated by a random phase θrand by the processing related to DSR. At stage B shown in FIG. 4, a basis B1 being a first candidate for basis is rotated by a random phase θrand by the processing related to DSR to become a basis B2 shown in FIG. 4. As a result, the symbol points S31 and S32 arranged at both ends of the basis B1 at stage A shown in FIG. 41 are respectively shown at positions indicated by symbol points S33 and S34 arranged at both ends of a basis B2 rotated by the random phase θrand.

Here, the symbol points S33 and S34 at stage B shown in FIG. 4 are arranged on the IQ plane equivalently to being arranged according to the basis B2 from the beginning. In other words, selecting the basis B1 as a candidate for basis and transmitting the symbol points S33 and S34 of which phase is rotated by the θrand by the processing related to DSR are equivalent to selecting the basis B2 and transmitting the signal from the beginning. In other words, the result of the processing related to DSR as described above is sufficiently transmitted as long as the symbol points S33 and S34 at stage B shown in FIG. 4 described above can be transmitted. In other words, the two stages A and B shown in FIG. 4 described above may be performed in sequence, or carrier waves may be directly modulated according to the basis B2 obtained as a result of stage B. Furthermore, stages A and B may be performed in reverse order. In other words, phase modulation corresponding to unit information for transmitting as the Y-00 optical quantum cryptography may be performed on the randomized carrier waves.

FIG. 5 is a schematic diagram showing a range of allowable randomization amounts of θrand at stage B shown in FIG. 4. The random phase θrand shown in FIG. 1 is randomly determined within the range of the randomization amount R in FIG. 5. The schematic diagram of FIG. 5 shows a case where a plurality of examples in which the symbol points S31 and S32 at stage A shown in FIG. 4 are rotated by a random phase grand by the processing related to DSR are superimposed. In the schematic diagram of FIG. 5, a plurality of symbol points corresponding to the symbol point S33 indicating 0 (zero) at stage B shown in FIG. 4 are arranged within the range of the randomization amount R in a region where the axis I is negative. Similarly, in the schematic diagram of FIG. 5, a plurality of symbol points corresponding to the symbol point S34 indicating 1 at stage B shown in FIG. 4 are arranged within the range of the randomization amount R in a region where the axis I is positive.

In other words, the symbol point S31 at stage A shown in FIG. 4 is randomized by the processing related to DSR, and is randomized and arranged at any one of the plurality of symbol points shown in FIG. 5. In other words, at stage B in FIG. 4, as a result of the processing related to DSR, a random phase θrand is determined to arrange the symbol point S31 within the range of the randomization amount R.

In the schematic diagram of FIG. 5, only 10 symbol points each representing 0 (zero) and 1 are shown, but the phase θrand when randomization can exist innumerably within the range of the randomization amount R.

Next, a description will be made with reference to the schematic diagram of FIG. 5 with respect to how the cryptographic signal randomized by the processing related to DSR is identified in the optical reception device 2. As a premise, the fact is shared that the cryptographic signal according to the basis B1 is transmitted to the optical reception device 2 in order to transmit the transmission data as Y-00 optical quantum cryptography. Therefore, the optical reception device 2 identifies the received cryptographic signal using a boundary orthogonal to the basis B1 shown at stage A in FIG. 4, that is, an axis Q in the example of FIG. 5. In other words, depending on existence of the cryptographic signal in any region of two regions divided by the axis Q as the boundary (a region including first, and fourth Quadrants and a region including second and third quadrants in the IQ plane in FIG. 5), it is possible to identify whether the cryptographic signal corresponds to the binary unit information of 0 (zero) or 1. In this way, the optical reception device 2 can be identified even when the random phase θrand due to the processing related to DSR is not shared in advance.

However, although not shown, if the randomization amount R is not appropriately adjusted and is too large, the optical reception device 2 may not be able to identify whether the signal corresponds to the binary unit information of 0 (zero) or 1. In other words, although not shown, symbol points corresponding to 0 (zero) and 1 are arranged in the opposite region of the region divided into two with the axis Q as the boundary in FIG. 5, whereby the cryptographic signal cannot be identified (erroneous identification).

Here, various types of noise are randomly generated between the optical transmission device 1 and the optical reception device 2 in other words, the various types of noise generated between the optical transmission device 1 and the optical reception device 2 are, for the optical reception device 2, indistinguishable from the random phase θrand due to be processing related to DSR. As a result, even though the randomization amount R is appropriate for the optical transmission device 1, the optical reception device 2 cannot identify the noise (erroneous identification). Therefore, the optical transmission device 1 of the present embodiment can appropriately adjust the randomization amount R in FIG. 5. In other words, although details will be described below, the optical transmission device 1 of the present embodiment can adjust the randomization amount R such that the optical reception device 2 can identify whether the signal corresponds to the binary unit information of 0 (zero) or 1.

Specifically, for example, the randomization amount R is adjusted such that the range SN of all kinds of “noise” including classical noise such as thermal noise in the optical reception device 2, which is the legitimate receiver, does not touch the boundary (the axis Q in the example of FIG. 5), Further, for example, the randomization amount R is adjusted such that the range of all kinds of “noise” including classical noise such as thermal noise is sufficiently far from the boundary (the axis Q in the example of FIG. 5). Here, it can be said that the range of “noise” is sufficiently far from the boundary if as follows. In other words, for example, when the unit information can be normally identified in the optical reception device 2, it can be said that the range of “noise” is sufficiently far from the boundary. Specifically, for example, when a bit error rate is sufficiently low (for example, a bit error rate is less than 10⁻⁹), it can be said that the range of “noise” is sufficiently far from the boundary. It is preferable to increase the randomization amount R within the range in which the unit information can the normally identified in the optical reception device 2. As a result, it is difficult for a third party who eavesdrops on the optical signal to decrypt the cryptographic signal.

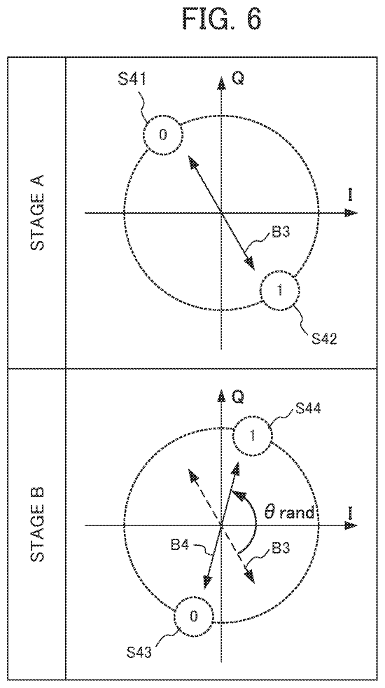

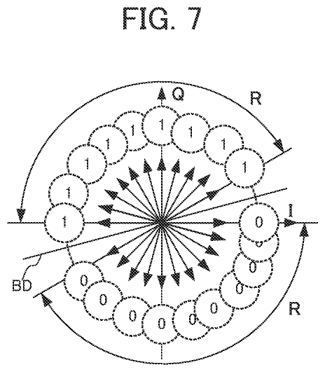

A description will be described below with reference to FIGS. 6 and 7 with respect to an example of randomization in a case of employing a basis different from the A modulation shown in FIG. 2, that is, a basis different from that used in the normal two-level modulation as a basis for transmitting as a Y-00 optical quantum cryptography. FIG. 6 is a diagram showing an example of a flow of randomization when each of the symbol points according to the basis different from the A modulation shown in FIG. 2 is randomized. In other words, 1-bit unit information that takes a binary value of 0 (zero) or 1 is used as unit information that takes a multi-level, and a basis different from the basis B1 at stage A shown in FIG. 4 is used as a basis for transmitting the 1-bit unit information as a Y-00 optical quantum cryptography.

First, candidates for basis are selected as the basis for transmitting as the Y-00 optical quantum cryptography. In stage A shown in FIG. 6, symbol points S representing binary unit information of 0 (zero) and 1 are arranged on an IQ plane according to a basis B3 selected as a candidate for basis.

Next, the candidates for basis are randomized by being rotated by a random phase θrand by the processing related to DSR. At stage B shown in FIG. 6, a basis B3 being a first candidate for basis is rotated by a random phase θrand by the processing related to DSP to become a basis B4 shown in FIG. 6. As a result, the symbol points S41 and S42 arranged at both ends of the basis B3 at stage A shown in FIG. 6 are respectively shown at positions indicated by symbol points S43 and S44 arranged at both ends of a basis B3 rotated by the random phase θrand.

Here, the symbol points S43 and S44 at stage B shown in FIG. 6 are arranged on the IQ plane equivalently to being arranged according to the basis B4 from the beginning. In other words, selecting the basis B3 as a candidate for basis and transmitting the symbol points S43 and S44 of which phase is rotated by the θrand by the processing related to DSR are equivalent to selecting the basis B4 and transmitting the signal from the beginning.

FIG. 7 is a schematic diagram showing a range of allowable randomization amounts of θrand at stage B shown in FIG. 6. The random phase θrand shown in FIG. 6 is randomly determined within the range of the randomization amount R in FIG. 7. The schematic diagram or FIG. 7 shows a case where a plurality of examples in which the symbol points S41 and S4 at stage A shown in FIG. 6 are rotated by a random chase θrand by the processing related to DSR are superimposed. In the schematic diagram of FIG. 7, a plurality of symbol points corresponding to the symbol point S43 indicating 0 (zero) at stage B shown in FIG. 6 are arranged within the range of the randomization amount R. Similarly, in the schematic diagram of FIG. 7, a plurality of symbol points corresponding to the symbol point S44 indicating 1 at stage B shown in FIG. 6 are arranged within the range of the randomization amount R.

In other words, the symbol point S41 at stage A shown in FIG. 6 is randomized by the processing related to DSR, and is randomized and arranged at any one of the plurality of symbol points shown in FIG. 7. In other words, at stage B in FIG. 6, as a result of the processing related to DSR, a random phase θrand is determined to arrange the symbol point S41 within the range of the randomization amount R.

In the schematic diagram of FIG. 7, only 10 symbol points each representing 0 (zero) and 1 are shown, but the phase θrand when randomization can exist innumerably within the range of the randomization amount R.

Next, a description will be made with reference to the schematic diagram of FIG. 7 with respect to how the cryptographic signal randomized by the processing related to DSR is identified in the optical reception device 2. As a premise, the fact is shared that the cryptographic signal according to the basis B1 is transmitted to the optical reception device 2 in order to transmit the transmission data as Y-00 optical quantum cryptography. Therefore, the optical reception device 2 identifies the received cryptographic signal using a boundary BD orthogonal to the basis B3 shown at stage A in FIG. 6. In other words, depending on existence of the cryptographic signal in any region of two regions divided by the boundary BD (a region on a positive side of the axis Q from the boundary BD and a region on a negative side of the axis Q from the boundary BD in the IQ plane in FIG. 6), it is possible to identify whether the cryptographic signal corresponds to the binary unit information of 0 (zero) or 1. In this way, the optical reception device 2 can be identified even when the random phase θrand due to the processing related to DSR is not shared in advance.

Although details will be described below, the selection of the basis B1 or the basis B3 in stage A in FIGS. 4 and 6 corresponds to basic encryption in the Y-00 protocol in which the basis is switched for each piece of unit information to be processed. In other words, it is shared with the legitimate receiver (for example, the optical reception device 2) that the cryptographic signal according to any one of the basis such as the basis B1 and the basis B3 is transmitted in order to transmit the transmission data as the Y-00 optical quantum cryptography. However, it is not shared with a third party, who eavesdrops on the optical signal, that the cryptographic signal any basis is transmitted. As a result, for example, if the symbol point on the axis I in a negative direction is received, the legitimate receiver can identify that the selected basis B1 corresponds to the unit information of 0 (zero) as shown in FIG. 5. Further, when the legitimate receiver can identify that the selected basis B3 corresponds to the unit information of 1 as shown in FIG. 7. However, the third party, who eavesdrops on the optical signal, cannot identify that the symbol point on the axis I in a negative direction corresponds to any unit information. Further, since the optical signal is randomized by the processing related to DSR, it is difficult for a third party who eavesdrops on the optical signal to decrypt it based on the periodicity of the cryptographic signal.

Although the phase modulation is used in the example of FIGS. 4 to 7, amplitude (intensity) modulation may be employed instead of or in addition to phase modulation. In other words, when performing the processing related to DSR together with the modulation of the optical signal using the Y-00 protocol, any modulation scheme such as intensity modulation, amplitude modulation, phase modulation, frequency modulation, and quadrature amplitude modulation may be employed.

In addition, although the case has been described in which the modulation number M is 2, the modulation number M is not limited to 2, and the randomization by the processing related to DSR can also be employed for any modulation number M, In other words, in the examples of FIGS. 4 to 7, 1-bit unit information that takes a binary value of 0 (zero) or 1 is used as unit information that takes a multi-level, symbol points corresponding to more bits may be employed. In this case, a randomization amount R corresponding to the inter-symbol point distance of a plurality of symbol points (for example, four symbol points in a case of 2-bit unit information) is employed as the randomization amount R.

The example of the flow of randomization by the processing related to DSR has been described above with reference to FIGS. 4 to 7. A detailed configuration example of the signal processing system shown in FIG. 1 will be described below with reference to FIG. 8.

FIG. 8 is a block diagram showing a detailed configuration example of the signal processing system shown in FIG. 1. FIG. 8 is a block diagram showing a detailed configuration example of the optical transmission device shown in FIG. 1. The optical transmission device 1 in the example of FIG. 8 include the transmission data provision unit 11, the cryptographic key provision unit 12, the cryptographic signal generation unit 13, and the cryptographic signal transmission unit 14, as shown in FIG. 1.

The optical transmission device 1 transmits multi-level information (for example, a bit string), in which one or more unit information (for example, a certain 1-bit) having a binary value such as 0 (zero) or 1 is arranged, as an optical signal.

The transmission data provision unit 11 generates plaintext data to be transmitted or acquires the plaintext data from a generation source (not shown), and provides the data as transmission data to the cryptographic signal generation unit 13.

The cryptographic key provision unit 12 provides the cryptographic signal generation unit 13 with the cryptographic key used for encryption in the cryptographic signal generation unit 13. The cryptographic key provision unit 12 in FIG. 8 includes a key provision section 111 and a key extension section 112.

The key provision section 111 provides the key extension section 112 with a cryptographic key (for example, a shared key) managed (shared) in advance between the optical transmission device 1 and the optical reception device 2.

The key extension section 112 extends the cryptographic key provided from the key provision section 111 using a predetermined algorithm, and provides the cryptographic signal generation unit 13 with the extended cryptographic key. Specifically, for example, an algorithm using a pseudo-random number generator (PRNG) can be employed as an example of the predetermined algorithm of the key extension section 112. In this case, the key extension section 112 can use the cryptographic key (common key) provided from the key provision section 111 as an initial key to generate a binary running key using the pseudo-random number generator, thereby extending the cryptographic key (common key). Further, for example, an algorithm using a linear feedback shift register (LFSR) can be employed as another example of the predetermined algorithm of the key extension section 112. In other words, the key extension section 112 can lengthen the cryptographic key provided by the key provision section 111 as compared with the cryptographic key. As a result, since the cryptographic signal generation unit 13 can generate a cryptographic signal using a cryptographic key with a longer period than the previously shared cryptographic key, even when a third party eavesdrops on the cryptographic signal, the risk of the cryptographic signal being decrypted can be reduced.

The cryptographic signal generation unit 13 encrypts the transmission data provided from the transmission data provision unit 11 using the cryptographic key provided from the cryptographic key provision unit 12, and provides the cryptographic signal transmission unit 14, which will be described below, with the signal. The cryptographic signal generation unit 13 shown in FIG. 8 includes a light source section 121, an optical modulation section 122, a basis selection section 123, a DSR section 124, a randomization amount adjustment section 125, and a randomization amount instruction section 126.

The light source section 121 generates an optical signal having a predetermined wavelength as a carrier wave and outputs the carrier wave to the optical modulation section 122 which will be described below.

The optical modulation section 122 modulates the optical signal, which is the carrier wave generated from the light source section 121, based on the basis selected by the basis selection section 123, and outputs the modulated signal to the cryptographic signal transmission unit 14 which will be described below. Specifically, for example, when phase modulation is employed as the modulation of the optical signal using the Y-00 optical quantum cryptography, the optical modulation section 122 is configured by a phase modulation element. Although not shown, the optical modulation section 122 may be configured by an interferometer configuration or a combination of various modulation elements, and may include one or more Mach-Zehnder modulators and IQ modulators, for example.

The basis selection section 123 selects, from each of piece or unit information, a basis for arranging each of one or more pieces of unit information (one or more multi-levels) making up the transmission data on the IQ plane, and causes the optical modulation section 122 to modulate the optical signal based on the selected basis. For example, the basis selection section 123 selects a basis to be applied to the unit information to be processed, based on the cryptographic key provided from the cryptographic key provision unit 12 and the random phase θrand adjusted by the randomization amount adjustment section 125 which will be described below.

Specifically, for example, first, the basis selection section 123 selects, based on the cryptographic key provided from the cryptographic key provision unit 12, the first candidate (for example, the candidate B1 in FIG. 4 or the candidate B3 in FIG. 6) for basis corresponding to stage A shown in FIGS. 4 and 6. The basis selection section 123 selects the candidate for basis for each piece of unit information to be processed. The selection of the candidate for basis by the basis selection section 123 corresponds to basic encryption in the Y-00 protocol in which the basis is switched for each piece of unit information to be processed. Next, the basis selection section 123 selects, based on the random phase grand adjusted by the randomization amount adjustment section 125 to be described below, the basis (for example, the basis B2 in FIG. 4 or the basis B3 in FIG. 6) corresponding to stage B shown in FIGS. 4 and 6 by rotating the phase of the candidate for basis. This corresponds to the processing related to DSR in which the randomization is performed on each piece of unit information to be processed. Conventionally, the random phase θrand is directly provided from the DSR section 124, which will be described below, to the basis selection section 123, but, in the present embodiment, is provided in a state of being adjusted by the randomization amount adjustment section 125 without being directly provided from the DSR section 121 which will be described below.

To summarize the above, the basis selection section 123 selects the basis for each piece of unit information based on the cryptographic key provided from the cryptographic key provision unit 12 and the random phase θrand adjusted by the randomization amount adjustment section 125 which will be described below. Then, the basis selection section 1123 controls the optical modulation section 122 based on the basis to modulate the optical signal for each piece of selected unit information. As a result, each of the pieces of unit information making up the transmission data provided from the transmission data provision unit 11 is arranged on the IQ plane based on each of the bases selected by the basis selection section 123. In other words, each of the pieces of unit information making up the transmission data is arranged as a symbol point on the IQ plane based on each of the bases selected by the basis selection section 123, and is output as an optical signal corresponding to the symbol point by the optical modulation section 122.

The DSR section 124 generates a random phase θrand used for randomization related to DSR based on the random number. In other words, the DSR section 124 generates, based on a predetermined random number, the phase θrand used for randomization related to DSR used by the basis selection section 123, and provided it to the randomization amount adjustment section 125. Thus, as described above, in the conventional processing related to DSR, the phase θrand generated by the DSR section 124 and used for randomization is directly provided to the basis selection section 123, but in the present embodiment, the phase θrand provided to the randomization amount adjustment section 125 and adjusted by the randomization amount adjustment section 125 is provided to the basis selection section 123.

The randomization amount adjustment section 125 adjusts the randomization amount when each of one or more pieces of unit information making up the transmission data (one or more multi-levels) is randomly arranged on the IQ plane. Then, the randomization amount adjustment section 125 adjusts the phase θrand based on the adjusted randomization amount, and provides the basis selection section 123 with the adjusted phase θrand. In other words, the randomization amount adjustment section 125 adjusts the randomization amount to be the amount R determined by the randomization amount instruction section 126 which will be described below. The randomization amount adjustment section 125 adjusts, based on the adjusted randomization amount R, the phase θrand generated by the DSR section 124 and used for randomization. Specifically, for example, the randomization amount adjustment section 125 adjusts the random phase θrand to be within the range of the randomization amount determined by the randomization amount instruction section 126. Thus, the basis selection section 123 selects the basis based on the random phase θrand adjusted to be within the range of the randomization amount R. As a result, the optical modulation section 122 modulates the signal to become a cryptographic signal corresponding to the random phase θrand being within the range of the randomization amount R.

The randomization amount instruction section 126 determines the randomization amount R based on evaluation information fed back from the optical reception device 2, and instructs the randomization amount adjustment section 125 to adjust with the randomization amount R. Specifically, for example, as an evaluation of the optical signal randomized by a first randomization amount R1, an evaluation is fed back that the randomization amount R1 is too large according to the evaluation. In this case, the randomization amount instruction section 126 determines a second randomization amount R2 smaller than the first randomization amount R1.

The cryptographic signal transmission unit 14 transmits the cryptographic signal (optical signal) to the optical reception device 2 as described with reference to FIG. 1. Specifically, for example, the cryptographic signal transmission unit 14 receives the cryptographic signal (optical signal) and transmits the signal to the optical reception device 2 through the optical communication cable 3 after amplifying and compensating the signal as necessary.

As described above, the cryptographic signal generation unit 13 shown in FIG. 8 uses the light source section 121 to the randomization amount instruction section 126 described above to generate the multi-level information as an optical signal, which is equivalent to the case where one or more multi-levels are randomly arranged on the IQ plane within the range of the randomization amount R according to the candidate for basis for transmitting as the Y-00 optical quantum cryptography. Thus, the randomness of the cryptographic signal is augmented within the range of the randomization amount R, whereby the security related to transmission and reception of the cryptographic signal is improved. Further, as described above, the randomization amount R is adjusted based on the feedback evaluation. Thus, errors in identification of unit information in an identification circuit 222 of the optical reception device 2 can be prevented. Hereinafter, a description will be made with respect to a flow of decryption of the cryptographic signal in the optical reception device 2 in which such evaluation is performed and a configuration related to the generation and feedback of: the evaluation.

As shown in FIG. 1, the optical reception device restores the plaintext data (transmission data) by decrypting the received cryptographic signal. Therefore, the optical reception device 2 includes a cryptographic signal reception unit 21, a cryptographic key provision unit 22, a cryptographic signal decryption unit 23, a communication quality monitor 24, and a feedback unit 25.

The cryptographic signal reception unit 21 receives the cryptographic signal (optical signal), and provides the signal to the cryptographic signal decryption unit 23 after amplifying and compensating the signal as necessary.

The cryptographic key provision unit 22 provides the cryptographic signal decryption unit 23 with the cryptographic key used during decryption of the cryptographic signal. The cryptographic key provision unit 22 shown in FIG. 8 includes a key provision section 211 and a key extension section 212. When the cryptographic key provision unit 22 manages and provides the shared key as a cryptographic key shared in advance between the optical transmission device and the optical reception device 2, the cryptographic key provision unit 22 perform basically the same function as the cryptographic key provision unit 12. In this case, the key provision section 211 and the key extension section 212 of the cryptographic key provision unit 22 perform basically the same functions as the key provision section 111 and the key extension section 112 or the cryptographic key provision unit 12, respectively.

As shown in FIG. 1, the cryptographic signal decryption unit 23 decrypts the cryptographic signal provided from the cryptographic signal reception unit 21 using the cryptographic key provided from the cryptographic key provision unit. 21:2, thereby restoring the plaintext data (transmission data). The cryptographic signal decryption unit 23 shown in FIG. 8 includes a basis selection section 221, an identification circuit 222, and a data management section 223.

The basis selection section 221 selects a basis based on the cryptographic key provided from the cryptographic key provision unit 22.

The identification circuit 222 identifies each of one or more pieces of unit information (for example, 1-bit unit information of 0 (zero) or 1) making up the multi-level information, based on the cartographic signal received by the cryptographic signal reception unit 21. In other words, the identification circuit 222 identifies the unit information based on the cryptographic signal received by the cryptographic signal reception unit 21 and the basis selected by the basis selection section 221.

The flow of identification by the identification circuit 222 will be described below with reference to FIG. 6. First, the basis selection section 221 selects the basis B3 based on the cryptographic key provided from the cryptographic key provision unit 22. The basis B3 is a basis selected in no consideration of the random phase θrand according to the basis by the basis selection section 123 of the optical transmission device 1 when transmitting. Next, since the cryptographic signal received by the cryptographic signal reception unit 21 is randomized by the random phase θrand, the cryptographic signal is arranged at the position of the symbol point S43 shown in FIG. 6 on the IQ plane. The identification circuit 222 uses a boundary BD orthogonal to the basis B3 selected by the basis selection section 221 as a reference to determine that the actually signal (the signal arranged at the position of the symbol point S43) is close to the symbol point S41 according to the basis B3, and thus identifies that the signal is unit information corresponding to 0 (zero).

The cryptographic signal received by the cryptographic signal reception unit 21 may further contain noise added by the optical communication cable 3 or an optical router, optical switch, and optical amplifier which are not shown. However, as described above, since the randomization amount R is appropriately adjusted by the randomization amount adjustment section 125 of the optical transmission device 1, the symbol points are not mixed beyond the boundary BD in the example of FIG. 7. In other words, as shown in FIG. 7, since the symbol point corresponding to 0 (zero) is not confused with the symbol point corresponding to 1, even when the phase θrand used for randomization by the processing related to DSR is not shared in advance, the cryptographic signal decryption unit 23 can identify the unit information.

The data management section 223 manages plaintext data in which one or more pieces of unit information identified by the identification circuit 222 are arranged.

The communication quality monitor 24 evaluates the result of identification of one or more pieces of unit information by the identification circuit 222. In other words, the communication quality monitor 24 generates and outputs an evaluation related to monitoring (confirmation and observation) of the communication quality of the plaintext data (transmission data) restored by the cryptographic signal decryption unit 23. Specifically, for example, the optical transmission device 1 transmits transmission data including bits related to error detection as a cryptographic signal. Thus, it is possible to detect whether errors are contained in the plaintext data in which one or more pieces of unit information identified by the identification circuit 222 are arranged. The communication quality monitor 24 can evaluate a ratio of plaintext data containing errors.

The feedback unit 25 feed backs the result evaluated by the communication quality monitor 24 to the optical transmission device 1. The evaluation fed back by the feedback unit 25 is used for adjusting the randomization amount determined by the randomization amount instruction section 126 described above.

To summarize the above, the cryptographic signal generation unit 13 of the optical transmission device 1 executes the processing related to DSR, whereby the randomness of the cryptographic signal transmitted from the optical transmission device 1 is augmented, the noise masking quantity is increased, and the security related to the transmission and reception of the cryptographic signal is improved. However, noise is further added by the optical communication cable 3 existing between the optical transmission device 1 and the optical reception device 2 or an optical router, optical switch, and optical amplifier which are not shown. As a result, when the randomization amount in the processing related to DSR is too large, there is a possibility that the identification circuit 222 of the optical reception device 2 may erroneously identify the unit information. Therefore, the optical reception device 2 of the present embodiment includes the communication quality monitor 24 and the feedback unit 25, and thus can feed back the evaluation related to the identification result of the unit information to the optical transmission device 1. The randomization amount adjustment section 125 of the optical transmission device 1 can adjust the randomization amount R based on the evaluation of the fed back identification result of the unit information. As a result, it is possible for the identification circuit 222 of the optical reception device 2 to prevent from erroneously identifying the unit information. Thus, it is possible to improve the security while preventing deterioration in the communication Quality between the optical transmission device 1 and the optical reception device 2, and thus to improve the convenience of transmitting and receiving the cryptographic signal.

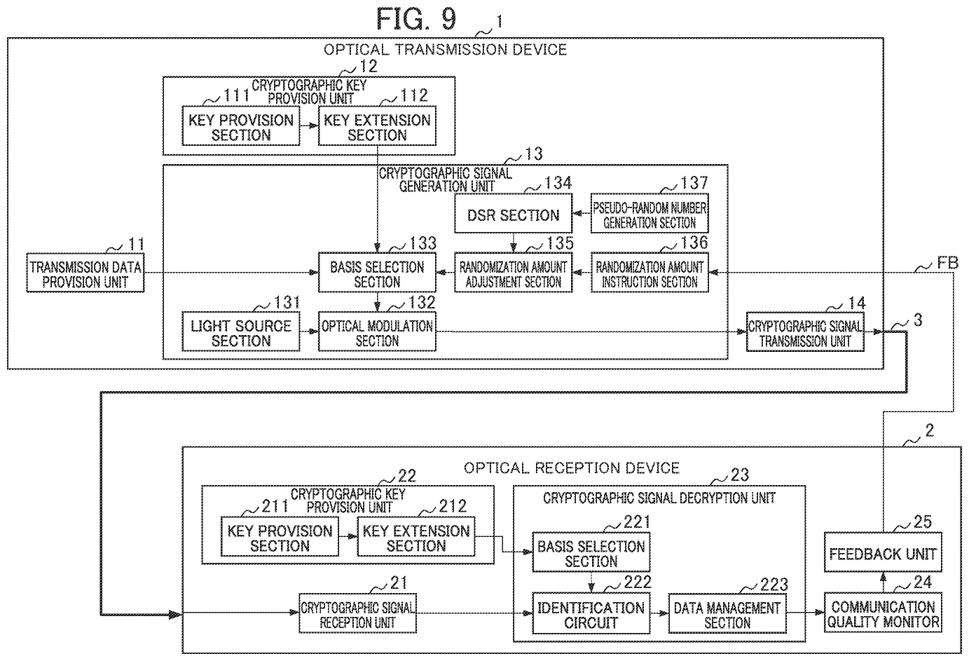

The detailed configuration example of the signal processing system shown in FIG. 1 has been described above with reference to FIG. 8. Another example of the detailed configuration example of the signal processing system shown in FIG. 1 will be described below with reference to FIGS. 9 to 12.

FIG. 9 is a block diagram showing another example differ ent from that shown in FIG. 8 in the detailed configuration example of the optical transmission device shown in FIG. 1. An optical transmission device 1 in the example of FIG. 9 includes a transmission data provision unit 11, a cryptographic key provision unit 12, a cryptographic signal generation unit 13, and a cryptographic signal transmission unit 14, as shown in FIG. 1. The optical transmission device 1 in the example of FIG. 9 has basically the same configuration as the optical transmission device 1 shown in FIG. 8 except the detailed configuration of the cryptographic signal generation unit 13. Further, the optical reception device 2 in the example of FIG. 9 has basically the same configuration as the optical reception device 2 shown in FIG. 9. Therefore, the cryptographic signal generation unit 13 of the optical transmission device 1 in the example of FIG. 9 will be described below.

The cryptographic signal generation unit 13 encrypts the transmission data provided from the transmission data provision unit 11 using the cryptographic key provided from the cryptographic key provision unit 12, and provides the cryptographic signal transmission unit 14, which will be described below, with the signal. The cryptographic signal generation unit 13 shown in FIG. 9 includes a light source section 131, an optical modulation section 132, a basis selection section 133, a DSR section 131, a randomization amount adjustment section 135, a randomization amount instruction section 136, and a pseudo-random number generation section 137.

The light source section 131 to the randomization amount instruction section 136 in FIG. 9 perform basically the same functions as the light source section 121 to the randomization amount instruction section 126 in FIG. 8, respectively.

The DSR section 134 generates a random phase θrand related to DSR based on the pseudo-random number generated by the pseudo-random number generation section 137. In other words, the DSR section 134 generates a random phase θrand related to DSR used by the basis selection section 133, based on the pseudo-random number generated by the pseudo-random number generation section 137.

The pseudo-random number generation section 137 generates a pseudo-random number using a predetermined algorithm. Specifically, for example, the pseudo-random number generation section 137 may employ the pseudo-random number generator in the key extension section 112 described above. However, unlike the example of the key extension section 112 described above, an initial key of the pseudo-random number generator in the pseudo-random number generation section 137 does not have to be shared with the optical reception device 2 in advance, and is appropriately set.

The light source section 131 to the randomization amount instruction section 136 in FIG. 9 perform basically the same functions as the light source section 121 to the randomization amount instruction section 126 in FIG. 8, respectively. As a result, the signal processing system having the functional configuration of FIG. 9 can achieve basically the same effects as described with reference to FIG. 8. However, due to the pseudo-random number generation section 137 in FIG. 9, such effects differ in following points from those described with reference to FIG. 8. In other words, the pseudo-random number can be generated by numerical calculation, and can be calculated using CPU (Central Processing Unit), FPGA (Field-Programmable Gate Array), or ASIC (Application Specific Integrated Circuit). Therefore, it can be implemented at a low cost compared with a case of the generation of a true random number which will be described below. In addition, the pseudo-random number generated by the pseudo-random number generation section 137 has periodicity according to a predetermined algorithm in a case of the generation of the pseudo-random number. However, the Y-00 protocol uses the shot noise of the optical signal having the nature of the true random number. In other words, even when the pseudo-random number is used in the processing related to DSR, the nature of true random number is realized by the shot noise according to the Y-00 protocol. Therefore, even when the pseudo-random number generated by the pseudo-random number generation section 137 is used, there is no special demerit due to the periodicity of the pseudo-random number, and the security of communication can be improved.

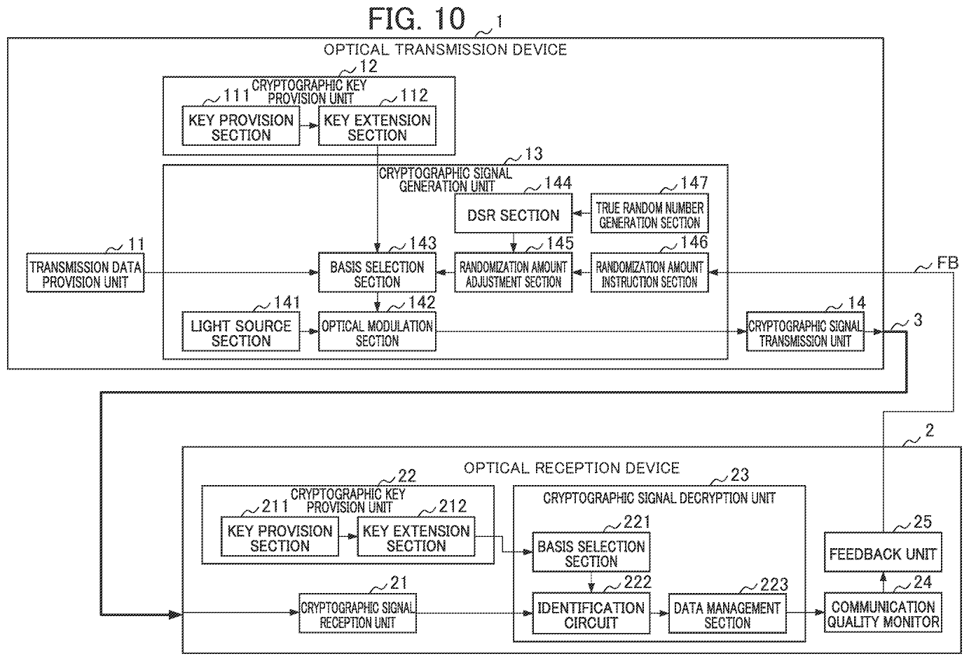

FIG. 10 is a block diagram showing another example different from those shown in FIGS. 8 and 9 in the detailed configuration example of the optical transmission device shown in FIG. 1. An optical transmission device 1 in the example of FIG. 10 includes a transmission data provision unit 11, a cryptographic key provision unit 12, a cryptographic signal generation unit 13, and a cryptographic signal transmission unit 14, as shown in FIG. 1. The optical transmission device 1 in the example of FIG. 10 has basically the same configuration as the optical transmission device 1 shown in FIG. 8 except the detailed configuration of the cryptographic signal generation unit 13. Further, the optical reception device 2 in the example of FIG. 10 has basically the same configuration as the optical reception device 2 shown in FIG. 8. Therefore, the cryptographic signal generation unit 13 of the optical transmission device 1 in the example of FIG. 10 will be described below.

The cryptographic signal generation unit 13 encrypts the transmission data provided from the transmission data provision unit 11 using the cryptographic key provided from the cryptographic key provision unit 12, and provides the cryptographic signal transmission unit 14, which will be described below, with the signal. The cryptographic signal generation unit 13 shown in FIG. 10 includes a light source section 141, an optical modulation section 142, a basis selection section 143, a DSR section 144, a randomization amount adjustment section 145, a randomization amount instruction section 146, and a true random number generation section 147.

The light source section 141 to the randomization amount instruction section 116 in FIG. 10 perform basically the same functions as the light source sec-ion 121 to the randomization amount instruction section 126 in FIG. 8.

The DSR section 144 generates a random phase θrand related to DSR based on the true random number generated by the true random number generation section 147. In other words, the DSR section 144 generates a random phase θrand related to DSP used by the basis selection section 143, based on the true random number generated by the true random number generation section 147.

The true random number generation section 147 generates a random number using a predetermined configuration. Specifically, for example, the true random number generation section 147 may employ a combination of a laser light source and a phase detector. In other words, for example, the true random number generation section 147 can generate a true random number using the shot noise of the optical signal having the nature of the true random number in the Y-00 protocol.

As a result, the signal processing system having the functional configuration of FIG. 10 can achieve basically the same effects as described with reference to FIG. 8. However, due to the true random number generation section 147 in FIG. 10, such effects differ in following points from those described with reference to FIG. 8. In other words, the random number generated by the true random number generation section 147 does not have the periodicity of the pseudo-random number generated by the pseudo-random number generation section 137 in FIG. 9 and has a nature that the next random number cannot be predicted based on the random number so far. As a result, not only the security of communication based on the Y-00 protocol but also the security of communicating the cryptographic signal can be further improved by the processing related to DSR.

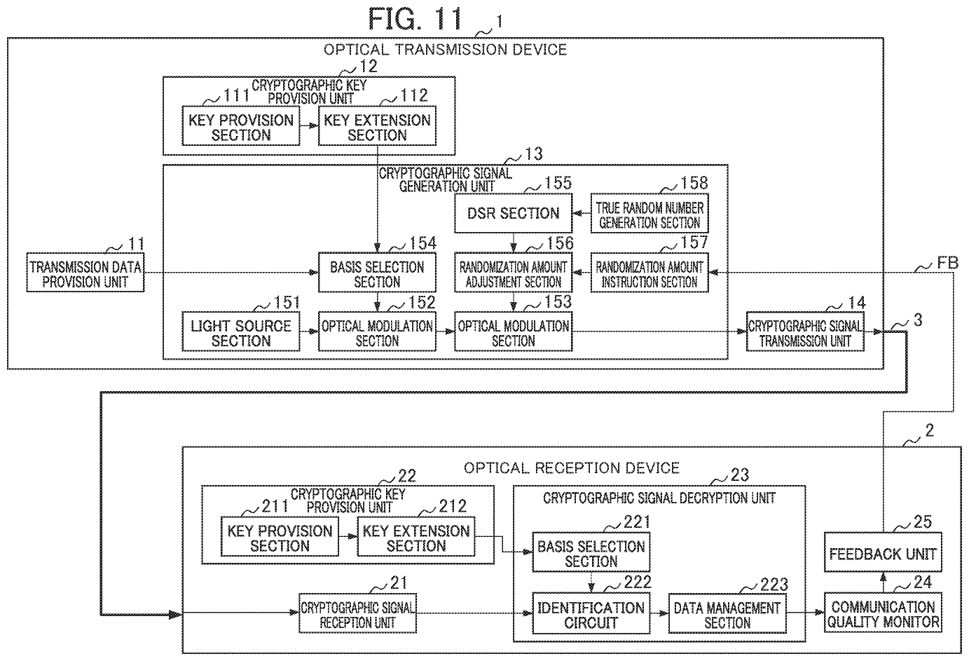

FIG. 11 is a block diagram showing another example different from those shown in FIGS. 8 to 10 in the detailed configuration example of the optical transmission device shown in FIG. 1. An optical transmission device 1 in the example of FIG. 11 includes a transmission data provision unit 11, a cryptographic key provision unit 12, a cryptographic signal generation unit 13, and a cryptographic signal transmission unit 14, as shown in FIG. 1. The optical transmission device 1 in the example of FIG. 11 has basically the same configuration as the optical transmission device 1 shown in FIG. 8 except the detailed configuration of the cryptographic signal generation unit 13. Further, the optical reception device 2 in the example of FIG. 11 has basically the same configuration as the optical reception device 2 shown in FIG. 8. Therefore, the cryptographic signal generation unit 13 of the optical transmission device 1 in the example of FIG. 11 will be described below.

The cryptographic signal generation unit 13 encrypts the transmission data provided from the transmission data provision unit 11 using the cryptographic key provided from the cryptographic key provision unit 12, and provides the cryptographic signal transmission unit 14, which will be described below, with the signal. The cryptographic signal generation unit 13 shown in FIG. 11 includes a light source section 151, an optical modulation section 152, an optical modulation section 153, a basis selection section 154, a DSR section 155, a randomization amount adjustment section 156, a randomization amount instruction section 157, and a true random number generation section 158.

The light source section 151 generates an optical signal having a predetermined wavelength as a carrier wave.

The optical modulation section 152 modulates the optical signal, which is the carrier wave generated from the light source section 121, based on the basis selected by the basis selection section 154. Specifically, for example, when phase modulation is employed as the modulation of the optical signal using the Y-00 protocol, the optical modulation section 152 is configured by a phase modulation element. Although not shown, the optical modulation section 152 may be configured by an interferometer configuration or a combination of various modulation elements, and may include one or more Mach-Zehnder modulators and IQ modulators, for example. Thus, for example, the optical signal of the symbol point. S41 in FIG. 6 is output from the optical modulation section 152.

The optical modulation section 153 further modulates the optical signal modulated by the optical modulation section 152, based on the random phase θrand adjusted by the randomization amount adjustment section 156. Specifically, for example, when phase modulation is employed as the modulation of the optical signal using the Y-00 protocol, the optical modulation section 153 is configured by a phase modulation element. Although not shown, the optical modulation section 152 may be configured by an interferometer configuration or a combination of various modulation elements, and may include one or more Mach-Zehnder modulators and IQ modulators, for example. Thus, for example, the optical signal of the symbol point S41 in FIG. 6 is further modulated and output, as the optical signal of the symbol point S43 in FIG. 6, from the optical modulation section 153.

The basis selection section 154 in FIG. 11 selects a basis for arranging each of one or more multi-levels on the IQ plane. In other words, the basis selection section 154 selects a basis based on the cryptographic key provided from the cryptographic key provision unit 12 and the transmission data provided from transmission data provision unit 11. Specifically, for example, the basis selection section 154 selects the basis B1 and the basis B3 as basis corresponding to stage A shown respectively in FIGS. 4 and 6, based on the cryptographic key provided from the cryptographic key provision unit 12. Further, for example, the basis selection section 154 selects a basis, based on the transmission data provided from the transmission data provision unit 11. In other words, the basis selection section 154 select sa basis corresponding to the symbol point S31 and a basis corresponding to the symbol point S32 at stage A shown in FIG. 4 based on whether the transmission data provide from the transmission data provision unit 11 is 0 or 1. To summarize the above, the basis selection section 154 selects a basis corresponding to the optical signal to be finally output, based on the transmission data provided from the transmission data provision unit 11, Then, the optical signal is modulated by the optical modulation section 152, based on the basis selected by the basis selection section 154, and each of one or more multi-levels is arranged on the IQ plane.

The DSR section 155 to the true random number generation section 158 in FIG. 11 perform basically the same functions as the DSR section 144 to the true random number generation section 147 in FIG. 10.

As a result, the signal processing system having the functional configuration of FIG. 11 can achieve basically the same effects as described with reference to FIG. 8. However, due to the optical modulation section 152 and the optical modulation section 153 in FIG. 11, such effects differ in following points from those described with reference to FIG. 8. In other words, in the optical transmission device 1 shown in FIG. 11, the optical modulation section 152 can perform modulation corresponding to the transmission data, and the optical modulation section 153 can perform modulation for the processing related to DSR. As a result, it becomes easy to transmit the cryptographic signal (optical signal) on which the randomization amount R adjusted by the randomization amount adjustment section 156 is reflected. In other words, an effect can be obtained in which the randomization amount R is easily adjusted according to the feedback from the feedback unit 25.

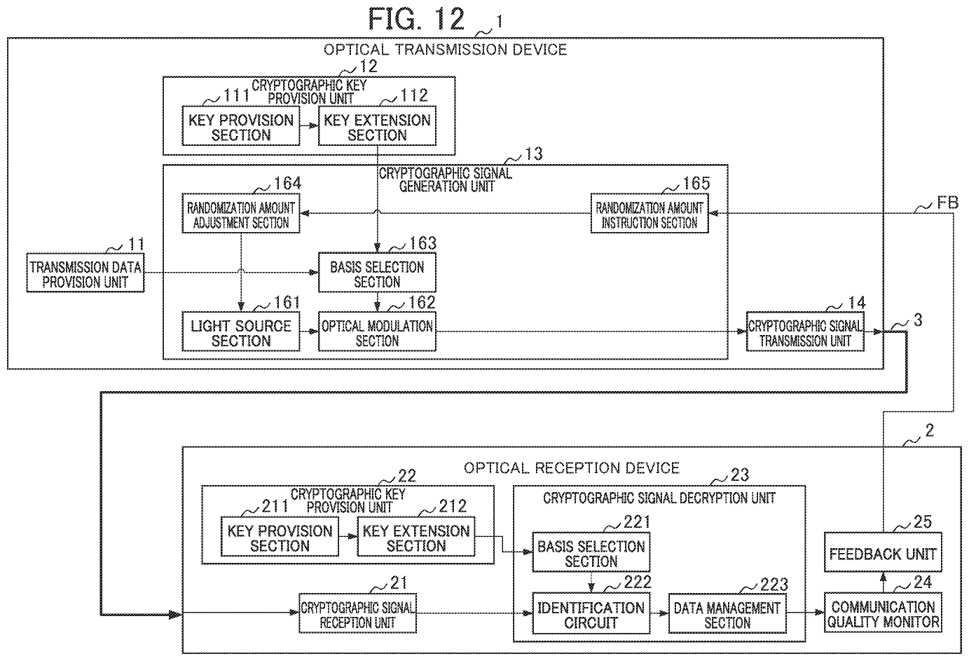

FIG. 12 is a block diagram showing another example different from those shown in FIGS. 8 to 11 in the detailed configuration example of the optical transmission device shown in FIG. 1. An optical transmission device 1 in the example of FIG. 12 includes a transmission data provision unit 11, a cryptographic key provision unit 12, a cryptographic signal generation unit 13, and a cryptographic signal transmission unit 14, as shown in FIG. 1. The optical transmission device 1 in the example of FIG. 12 has basically the same configuration as the optical transmission device 1 shown in FIG. 8 except the detailed configuration of the cryptographic signal generation unit 13. Further, the optical reception device 2 in the example of FIG. 12 has basically the same configuration as the optical reception device 2 shown in FIG. 8. Therefore, the cryptographic signal generation unit 13 of the optical transmission device 1 in the example of FIG. 12 will be described below.

The cryptographic signal generation unit 13 encrypts the transmission data provided from the transmission data provision unit 11 using the cryptographic key provided from the cryptographic key provision unit 12, and provides the cryptographic signal transmission unit 14, which will be described below, with the data. The cryptographic signal generation unit 13 shown in FIG. 11 includes a light source section 161, an optical modulation section 162, a basis selection section 163, a randomization amount adjustment section 164, and a randomization amount instruction section 165. The light source section 161 generates, as a carrier wave, an optical signal having a predetermined wavelength and stability corresponding to the randomization amount R adjusted by the randomization amount adjustment section 164. In other words, the light source section 161 can generate a carrier wave with unstable randomness corresponding to the randomization amount R adjusted by the randomization amount adjustment section 164.

The optical modulation section 162 modulates the optical signal, which is the carrier wave generated from the light source section 161, based on the basis selected by the basis selection section 163. Specifically, for example, when phase modulation is employed as the modulation of the optical signal using the Y-00 protocol, the optical modulation section 162 is configured by a phase modulation element. Although not shown, the optical modulation section 162 may be configured by an interferometer configuration or a combination of various modulation elements, and may include one or more Mach-Zehnder modulators and IQ modulators, for example. Thus, for example, the optical signal of the symbol point S43 in FIG. 6 is output from the optical modulation section 162.

The basis selection section 163 performs basically the same function as the basis selection section 154 shown in FIG. 11. The randomization amount adjustment section 164 and the randomization amount instruction section 165 perform basically the same functions as the randomization amount adjustment section 125 and the randomization amount instruction section 126 in FIG. 8, respectively.

Various embodiments of the optical transmission device 1 and the optical reception device 2 according to the present invention have been described above. However, the optical transmission device 1 or the optical reception device 2 according to the present invention is sufficient as long as being capable of improving the transmission/reception equipment and transmission efficiency per hour of the transmission data after encryption in the physical layer, and the configuration thereof is not limited to the various embodiments described above and may be as follows, for example.

For example, in the embodiments described above, for the convenience of the description, the optical communication cable 3 is employed as the transmission path for the optical signal transmitted from the optical transmission device 1 and received by the optical reception device 2, but there is no particular limitation to this. For example, a device for optical communication such as an optical amplifier, an optical switch, or a wavelength switch may be inserted between the optical communication cable 3 and the optical transmission device 1 or the optical reception device 2. In addition, an optical transmission path is not limited to something that uses an optical fiber, and may comprise a communication path such that propagation is performed over a so-called optical wireless space, for example. Specifically, for example, a vacuum space including air, water, and universe may be employed as the optical transmission path. In other words, any communication channel may be used between the optical communication cable 3 and the optical transmission device 1 or the optical reception device 2.

Further, for example, the transmission data provision unit 11 is incorporated in the optical transmission device 1, but the transmission data may be received from outside of the optical transmission device in accordance with a predetermined reception unit that is wired or wireless, by providing the transmission data reception unit (not shown). Furthermore, a storage device (not shown) or removable media may be used to provide the transmission data. In other words, the transmission data provision unit may have any kind of transmission data obtainment unit.

For example, the cryptographic key provision unit 12 may provide a key sufficient for the cryptographic signal generation unit 13 to generate multi-level data relating to encryption. In other words, the cryptographic key may be a shared key, and may be a key that uses a different algorithm such as a private key and a public key.

For example, the light source section 121 does not need to be incorporated in the optical transmission device 1. In other words, the optical transmission device 1 may be an optical signal multiplexing/encryption device that is inputted with a carrier wave and transmits a cryptographic signal. Furthermore, the optical signal multiplexing/encryption device may input n optical signals which are a carrier wave on which transmission data is already placed, provide and multiplex the clock signal, and perform multi-level modulation for encryption.

The cryptographic signal transmission unit 14 performs processing such as amplifying the intensity of the cryptographic signal as needed, hut configuration may be taken to not incorporate the cryptographic signal transmission unit 14 in the optical transmission device 1, have the optical transmission device 1 output cryptographic data without amplification, and use an external optical signal amplification device (not shown).

For example, in the embodiments described above with reference to FIGS. 4 to 11, for the convenience of the description, the modulation for the processing related to DSR is performed on an optical signal that had been subjected to the modulation related to the transmission data, but there is no particular limitation to this. In other words, the modulation related to the transmission data and the modulation for the processing related to DSR may be performed in any order. Furthermore, the modulation related to the transmission data and the modulation for the processing related to DSR may be performed on any path of an interferometer configuration that branches into any number of paths, and the modulated signal may be subject to interference any number of times at any location. Furthermore, other interferometer structures may be provided behind be interferometer configuration. In other words, for example, a Mach-Zehnder modulator cascaded in multiple stages or an IQ modulator cascaded in multiple stages may be used.

Note that the configurations of the optical transmission device 1 and the optical reception device 2 are not limited to those described above when the phase modulation is employed as modulation of the optical signal using the Y-00 protocol. In other words, the cryptographic signal generation unit 13 may be configured by direct modulation of a laser or a combination of a laser and various modulation elements. Specifically, for example, in the example of FIG. 6, the cryptographic signal generation unit 13 may be configured by a light source section 121 (laser light source with a predetermined wavelength) and one or more modulation elements (for example, a phase modulator, Mach-Zehnder modulator, and an IQ modulator). Further, for example, the light source section 121 may include a modulated laser generation unit and may be configured to directly output a modulated optical signal. Further, the encryption section 113 may be configured by one or more modulation elements (for example, a phase modulator, Mach-Zehnder modulator, and an IQ modulator). Specifically, for example, the cryptographic signal generation unit 13 may employ a k-stage (k being an integer equal to or greater than 1) modulator instead of the one-stage modulator for the modulation related to the transmission data.

In the present embodiment, the feedback and the instruction of the randomization amount based on the feedback are performed by a predetermined signal path and information processing (for example, an Internet line (not shown) from the feedback unit 25 and data processing in the randomization amount instruction section 136), but it is not particularly limited thereto. In other words, for example, a person who reads the evaluation related to the communication quality monitoring generated by the communication quality monitor 24 may adjust the randomization amount P by operating the randomization amount adjustment section 135. In other words, the adjustment of the randomization amount R is to prevent the optical reception device 2 from being unable to identify (erroneous identification) due to various types of noise between the optical transmission device 1 and the optical reception device 2, even though the randomization amount R is appropriate for the optical transmission device 1. Various types of noise between the optical transmission device 1 and the optical reception device 2 usually do not fluctuate significantly, and is sufficient to be checked in a case of the installation of the optical transmission device 1 and the optical reception device 2 or on a regular period. Therefore, the feedback and the instruction of the randomization amount based on the feedback need not be performed by a predetermined signal path and information processing as in the present embodiment.

Further, for example, the randomization of the carrier waves by the randomization amount adjustment section 164 and the light source section 161 in the example of FIG. 12 may be performed as follows. In other words, for example, several types of light source sections with different stabilities are prepared in advance as light source sections for generating carrier waves, and an appropriate one may be selected and used (replaced as appropriate) from the several types of light source sections. In other words, the stability of the phase or the carrier wave generated from the light source section is nothing but the randomized carrier wave generated based on the randomization amount R adjusted by the randomization amount adjustment section 164. Therefore, it is possible to smoothly adjust the randomization amount in a case of the installation of the optical transmission device 1 and the optical reception device 2 by preparing several types of light source sections with different stabilities in advance and selecting and using an appropriate one.

To summarize the above, it is sufficient if a signal processing system to which the present invention is applied is as follows, and various embodiments can be taken. In other words, a signal processing system (for example, the signal processing system shown in each of FIGS. 1 and 8 to 12) to which the present invention is applied comprises at least:
a transmission device (for example, the optical transmission device 1 in FIG. 1) that transmits, as an optical signal, multi-level information in which one or more pieces of multi-level unit information (for example, one bit of 0 (zero) or 1, or more bits) are arranged; and
a reception device (for example, the optical reception device 2 in FIG. 1) that receives an optical signal transmitted from the transmission device,
the transmission device including:
a basis selection unit (for example, the basis selection section 123 in FIG. 8) for selecting a basis used to arrange the one or more pieces of multi-level unit information on an IQ plane;
a randomization amount adjustment unit (for example, the randomization amount adjustment section 125 in FIG. 8) for adjusting the randomization amount in a case of the random arrangement of the one or more pieces of multi-level unit information on the IQ plane;
an optical signal generation unit (for example, the cryptographic signal generation unit 13 including the light source section 121 and the optical modulation section 122 in FIG. 8) for generating, as an optical signal, the multi-level information equivalent to the random arrangement of the one or more pieces of multi-level unit information on the IQ plane within a range of the randomization amount according to the basis; and
an optical signal transmission unit (for example, the cryptographic signal transmission unit 14 in FIG. 8) for transmitting the optical signal to the reception device,
the reception device including
an optical signal reception unit (for example, the cryptographic signal reception unit 21 in FIG. 8) for receiving the optical signal transmitted from the transmission device;
an identification unit (for example, the identification circuit 222 in FIG. 8) for identifying the one or more pieces of unit information making up the multi-level information, based on the optical signal received by the optical signal reception unit;
an evaluation unit (for example, the communication quality monitor 24 in FIG. 8) for evaluating a result of the one or more pieces of unit information identified by the identification unit; and
a feedback unit (for example, the feedback unit 25 in FIG. 8) for feeding back a result evaluated by the evaluation unit to the transmission device.

Thus, the optical signal transmitted from the transmission device is randomized, and a large fluctuation (noise) is added to the cryptographic signal (optical signal) transmitted from the optical transmission device 1, thereby improving the security in transmission and reception of data. Then, at that time, the reception device feeds back the evaluation related to the identification result, and thus the transmission device transmits an optical signal with an appropriate randomization amount on which a fluctuation (noise) between the transmission device and the reception device is reflected.

### EXPLANATION OF REFERENCE NUMERALS

1 . . . optical transmission device, 11 transmission data provision unit, 12 . . . cryptographic key provision unit, 111 . . . key provision section, 112 . . . key extension section, 13 . . . cryptographic signal generation unit, 113 . . . encryption section, 121 . . . light source section, 122 . . . optical modulation section, 123 . . . basis selection section, 124 . . . DSR section, 125 . . . randomization amount adjustment section, 126 . . . randomization amount instruction section, 14 . . . cryptographic signal transmission unit, 2 . . . optical reception device, 21 . . . cryptographic signal reception unit, 211 . . . key provision section, 212 . . . key extension section, 22 . . . cryptographic key provision unit, 23 . . . cryptographic signal decryption unit, 221 . . . basis selection section, 222 . . . identification circuit, 223 . . . data management section, 24 . . . communication quality monitor, 25 . . . feedback unit, 3 . . . optical communication cable, 131 . . . light source section, 132 . . . optical modulation section, 133 . . . basis selection section, 134 . . . DSR section, 135 . . . randomization amount adjustment section, 136 . . . randomization amount instruction section, 137 . . . pseudo-random number generation section, 141 . . . light source section, 142 . . . optical modulation section, 143 . . . basis selection section, 144 . . . DSR section, 145 . . . randomization amount adjustment section, 146 . . . randomization amount instruction section, 147 . . . true random number generation section, 151 . . . light source section, 152 . . . optical modulation section, 153 . . . optical modulation section, 154 . . . basis selection section, 155 . . . DSP section, 156 randomization amount adjustment section, 157 . . . randomization amount instruction section, 158 . . . true random number generation section, 161 . . . light source section, 162 . . . optical modulation section, 163 . . . basis selection section, 164 . . . randomization amount adjustment section, 165 . . . randomization amount instruction section

1. A signal processing system comprising at least:
a transmission device that transmits, as an optical signal, multi-level information in which one or more pieces of multi-level unit information are arranged; and
a reception device that receives the optical signal transmitted from the transmission device,
the transmission device including:
basis selection unit for selecting a basis used to arrange the one or more pieces of multi-level unit information on an IQ plane;
a randomization amount adjustment unit for adjusting the randomization amount in a case of random arrangement of the one or more pieces of multi-level unit information on the IQ plane;
an optical signal generation unit for generating, as an optical signal, the multi-level information equivalent to the random arrangement of the one or more pieces of multi-level unit information on the IQ plane within a range of the randomization amount according to the basis; and
an optical signal transmission unit for transmitting the optical signal to the reception device,
the reception device including:
an optical signal reception unit for receiving the optical signal transmitted from the transmission device;
an identification unit for identifying the one or more pieces of unit information making up the multi-level information, based on the optical signal received by the optical signal reception unit;
an evaluation unit for evaluating a result of the one or more pieces of unit information identified by the identification unit; and
feedback unit for feeding back a result evaluated by the evaluation unit to the transmission device.
